(19) United States
(12) Patent Application Publication
(10) Pub. No.: US 2013/0077765 A1
(43) Pub. Date: Mar. 28, 2013

(54) DIGITAL RADIOGRAPHY MECHANICAL POSITIONING SYSTEM

(71) Applicant: Thomas J. Welsh, Aurora, IL (US)

(72) Inventor: Thomas J. Welsh, Aurora, IL (US)

(21) Appl. No.: 13/627,914

(22) Filed: Sep. 26, 2012

Related U.S. Application Data
(60) Provisional application No. 61/539,448, filed on Sep. 26, 2011.

(51) Int. Cl. H05G 1/02

(52) U.S. Cl. 378/198; 378/197

(57) ABSTRACT

The present invention is a rotary C-arm type of digital radiographic mechanical positional system mounted on a floor that includes a fixed vertical column with a rotational freedom, an X-ray source that provides the system with a plurality of X-rays and a locking rotary C-arm. The system also includes a single image collector disposed on the distal end of the rotary arm, a rotatable wheeled trolley that is attached to the rotary C-arm and the X-ray source and one or more safety stops. The system can also be a radiographic mechanical positional Bucky system. The present invention provides a hybrid design combining the benefits of both C-arm and Bucky systems, while providing greatly improved safety features not previously available on these systems.

This application claims priority to U.S. Provisional Application No. 61/539,448 filed on Sep. 26, 2011, the entire disclosure of which is incorporated by reference.

### TECHNICAL FIELD & BACKGROUND

The medical industry has used radiographic or X-ray images to diagnose patient conditions for many years. The medical profession has developed a set of preferred exposure positions that are most commonly used to diagnose patients with various injuries. Some of these exposure positions are taken using a vertical beam with the patient lying on a table between the X-ray source and the image collector. Others are taken using a horizontal beam with the patient standing between the X-ray source and the image collector. The X-ray process requires an X-ray beam to be directed toward a patient. As the beam passes through the patient, some beam energy is absorbed by the body. X-ray beam absorption is proportional to the density of the matter it encounters. Medical radiographic film was invented many years ago to capture the energy that passes through the patient. After exposure and processing, the film produces an image. More recently, digital imaging technology was developed to collect radiographic images in a similar patient exposure manner known as digital radiography. The only difference between film radiography and digital radiography is the collection, transfer and storage of the radiographic images.

X-rays are relatively harmful to people, yet this is outweighed by the relative value of the X-ray image that allows a doctor to look inside the body. It is therefore the goal of the doctor to get the very best image possible while exposing the patient to the least amount of radiation. A relatively poor image produced typically requires the retaking of another X-ray exposure. The most common cause for a relatively poor image is patient movement during the exposure. The second most common cause for a relatively poor image is X-ray technician error.

Digital radiographic equipment has relatively improved and evolved over time. This has resulted in a relative decreased dose of radiation required to obtain a relatively good image. Many of the systems developed for this technology are highly sophisticated to minimize technician error, and are therefore relatively expensive. Digital radiography remains less expensive than other medical imaging technologies. The current trend in the medical industry is to simplify and lower the cost of digital radiographic equipment. All companies in the digital radiographic equipment business are also competing to win market share in emerging economies of highly populated countries.

There are basically three types of major medical radiographic positioning systems, a ceiling mounted system, a rotary C-arm system and the Bucky system.

Ceiling mounted positioning systems position a hanging X-ray source. The ceiling mounted positioning system is relatively expensive and requires special installation in a building. The benefit of the ceiling mounted positioning system is that the floor space is open. The exposures can be captured by either a table or a wall-stand type collector.

The rotary C-arm positioning system is floor mounted. The rotary C-arm positioning system has one fixed vertical column. A wheeled trolley is captivated on the fixed vertical column to allow a C-arm to move up and down. The C-arm supports both the X-ray source and the image collector and secures them in an aligned position to take exposures. The C-arm is rotationally coupled to a trolley. The X-ray source and the image collector have linear motion to allow the operator to change the distance between the X-ray source and the image collector. This distance is called the source-image distance or SID. These three degrees of freedom allow the C-arm system to take exposures for both table and wall-stand use modes. The vertical column must be bolted to a floor with sufficient strength to support the system. Most C-arm systems are motorized with computer controlled motion with crash sensing safety capability.

When the C-arm is rotated in a vertical position, and the image collector is toward the bottom and the X-ray source is on top, a table type exposure can be taken. This is a table use mode and these exposures are very common because often a patient that is in need of radiographic diagnosis is physically impaired and unable to stand. The C-arm system is rather inconvenient for the table use mode because the only freedom of movement available is up and down. Therefore, the patient on the table must be moved around and adjusted to take a relatively good exposure. There is not an integral patient table utilized with the C-arm system.

When the C-arm is rotated in a horizontal position, the patient can stand in front of the image collector. This mode is a wall-stand use mode. Here the C-arm system is more convenient as the C-arm can be moved up and down over a full range, and the source-image distance or SID is relatively easily adjustable.

The Bucky system pre-dates the C-Arm system and was originally developed for X-Ray film. The Bucky system has two vertical columns. One is a tube-stand with an X-ray source that is mounted on an arm that is attached to a trolley that can roll up and down the tube-stand for vertical positioning. The tube-stand assembly is mounted on a plurality of floor rails so it can be rolled along the length of the patient table. The Bucky system is in table use mode when the tube-stand is positioned on the floor rails such that the X-ray source is over the patient table to capture exposure images on image collector 1. The floor rails extend beyond the end of the patient table and therefore allow the positioning of the tube-stand for wall-stand use mode. The second vertical column is a wall-stand and is fixed and fastened to the floor and supports an image collector 2 that can be vertically positioned by a second trolley.

The Bucky system uses a dedicated patient table that is fastened to the floor. The table top is laterally moveable relative to the fixed table base in two directions. This allows an X-ray technician to move the table top while the patient still remains on the table top. The image collector 1 is dedicated to the table use mode only and is located under the floating table top. The floating table top and the moveable tube-stand permit a relatively large area of coverage without having to physically move the patient on the floating table top which is one of the positive features of the Bucky system.

The Bucky system is in wall-stand use mode when the tube-stand is rolled on the floor rails, beyond the end of the patient table, and the X-ray source is rotated approximately 90 degrees to horizontal beam direction, where the beam is directed toward image collector 2. In this mode there is freedom to move the X-ray source, as well as the image collector 2, up and down, from floor level to the top of the two vertical columns. Image collector 2 is dedicated to the wall-stand use mode only.

The Bucky system is typically a manual positioning system requiring the operator to release a brake to physically reposition and relock the equipment to take a desired exposure. A critical element in this process is attaining alignment of the X-ray beam to the image collector. Having two use modes and two image collectors presents alignment difficulties that are not present with the C-arm type system. It is therefore preferable to have one image collector that is always mechanically coupled to the X-ray source.

The Bucky system must enable the operator to align the X-ray beam to the desired image collector. This can be achieved in table use mode by providing a mechanical link between the X-ray source and image collector 1. The coupler for table use mode is preferably mechanical because an alignment method using light is impeded as the table and patient are between the two entities to be aligned. The mechanical coupler must also automatically decouple when the tube-stand is rolled away from the table to enter the wall-stand use mode. It is impractical to then mechanically re-couple the X-ray source to the wall-stand use image collector 2. This mode can be aligned by either lights, or by the operator reading positioning markers on the wall-stand and tube-stand to attain the same height. The coupling issue is a detriment to the Bucky system.

A recent product introduction of a Bucky system included two innovations. Firstly, the floor rails were eliminated by integrating all of the tube-stand motion guides within extended table sections. Secondly, the power components were placed within the patient table chassis.

The elimination of the floor rails is a desirable goal. The drawback is that the tube-stand rail system protrudes outward and the table top floats from side to side. In all other float positions, one or the other extensions will protrude out further than the offset table. This encumbers mobility around the table with a potential tripping hazard. Elimination of these extensions would be an improvement.

Placing the high voltage components directly under the patient has the advantages of overall system space reduction and shortened cable lengths. There are also potential drawbacks such as a potential electrocution hazard, a lack of ventilation, overheating and possible fan noise.

The aforementioned recent Bucky system was designed to be relatively easy to set-up in a medical facility. The space required to install the system is minimized. The system footprint is approximately 5.5 meters in length by approximately 4 meters in width which is approximately 22 square meters. The need for structural modifications to the room into which the system will be installed is also minimized. The system uses a plurality of internal rollers for the tube-stand and wall-stand as well.

Safety is of paramount concern in all products, but especially in the medical equipment field. Both the C-arm and the Bucky systems have deficiencies with regards to safety. The vertical range of motion allows the C-arm to be lowered until the image collector is at floor level and can be raised to the uppermost level allowed by the vertical column. The C-arm also has rotational motion freedom that allows the operator to pivot the C-arm about the central axis of the trolley. There is also a third motion of freedom that allows the operator to vary the source-image distance SID between the X-ray source and the image collector. These two entities are coupled such that they move toward or away from each other in unison to maintain a balanced C-arm. Each of the three motions is locked by electro-magnetic brakes and the operator controls the brakes using the three buttons visible on the right side of the C-arm.

There are two potential safety hazards with this design. One is related to the operator or X-ray technician and the other is related to the patient. The system can be driven into the floor, the ceiling, or the patient if the vertical position of the C-arm is too high or too low and the C-arm is then rotated, and/or the image collector is extended. There is a minimum height at which the trolley holding the C-arm must be raised to allow full rotation of the C-arm without a floor crash. The same holds true for the ceiling (depending upon the ceiling height). Some C-arm systems are motorized and require sensors and software to prevent crashes and minimize crash impact. There are also non-motorized, manually operated C-arm systems where it is solely up to the operator to safely manipulate these systems to avoid a crash. Clearly, a system that alleviates this problem would be an improvement.

The second hazard involves the brake release buttons. Generally, X-ray exposures involve at least two people: the patient and the X-ray technician. The patient does not know anything about the X-ray machine except its purpose. It is foreseeable that the patient lying on the table might grip the system positioning bar to get-up and accidentally push one or more of the brake release buttons. This could cause the system to crash into the patient. Clearly, a system that alleviates this problem would be an improvement.

The Bucky positioning system was originally developed many years ago for use with X-ray film. It was designed to accommodate the two basic use modes, a table use model and a wall-stand use model. The same two potential hazards noted for the C-arm also exist for the Bucky system. The first hazard is operator or X-ray technician related. The range of motion for the floor rails and the vertical range of motion for the tube-stand allow for potential crashes. There are two trolleys that can move down close to the floor and up to the top of the vertical columns. This is required to attain the full range of exposure positions required for wall-stand use mode. The table top is movable such that it can be slid to the left to prevent this crash. If the X-ray source were then lowered to below the table top level, the tube-stand can roll along the floor rails and crash into the right side of the table.

The same second hazard situation exists where patients can accidentally push a brake release button and pull the X-ray source down upon themselves. The brake release buttons are located at the end of the tubular grips, to the right and left of the X-ray tube, directly above the patient table. The positioning grips are there to facilitate the technician to manipulate the machine. But they are also directly above a patient lying on the table and offer the patient a capability to pull him or herself to get-up. If the patient reaches up to pull-up on the grip bars and accidentally pushes the vertical brake release button, the X-ray tube arm will be pulled down into the patient.

The primary benefit of the C-arm system is that the X-ray source and image collector are always mechanically coupled. A secondary benefit of the C-arm system is that it requires relatively less area than the Bucky system. A third benefit of the C-arm system is that there are other exposure angles available between horizontal and vertical beam directions. The primary weakness of the C-arm system is that the potential exists for system crashes into the patient, the table, the floor or the ceiling. A secondary weakness of the C-arm system is that it is more difficult to use for table use as the table must be wheeled and positioned with respect to the system.

The primary benefit of the Bucky system is that table use mode allows exposures over the entire length of the patient while the patient still remains on the table top. The system is adjusted to attain all desired exposures. The primary weakness of the Bucky system is that the potential exists for system crashes into the patient or the table. A secondary weakness of the Bucky system is the requirement for two vertical columns and two image collectors. A third weakness of the Bucky system is the difficulty in aligning the X-ray source to the two image collectors. A fourth weakness of the Bucky system is the need for floor rails. This presents the need to modify the building into which the system will be installed, and presents a tripping hazard that impedes mobility around the system.

### SUMMARY OF THE INVENTION

The present invention is a digital radiography mechanical positioning system. More specifically, the present invention is applicable to either film or digital radiography as it involves a mechanical system that positions an X-ray beam, a patient, and an image collector.

It is an object of the present invention to provide a digital radiography mechanical positioning system that permits a wide range of a plurality of common exposure positions.

It is an object of the present invention to provide a digital radiography mechanical positioning system that produces a plurality of exposures in a relatively small area.

It is an object of the present invention to provide a digital radiography mechanical positioning system that utilizes a single, non-portable, image collector that offers a cost advantage and alleviates potential collector damage during transport.

It is an object of the present invention to provide a digital radiography mechanical positioning system that prevents accidental crash of the X-ray source or the image collector into a patient, a patient table, or a floor.

It is an object of the present invention to provide a digital radiography mechanical positioning system that provides a digital radiography mechanical positioning system with a relatively low-cost manually operated system that would be affordable, reliable, simple, intuitive, and safe.

It is an object of the present invention to provide a digital radiography mechanical positioning system that utilizes a single vertical column and one image collector that is always mechanically coupled to an X-ray source with a source-image distance or SID adjustment.

It is an object of the present invention to provide a digital radiography mechanical positioning system that utilizes a dedicated patient table with a floating top to provide similar coverage as a Bucky system.

It is an object of the present invention to provide a digital radiography mechanical positioning system that utilizes a rail structure that is completely self-contained within a bottom of a table to eliminate a tripping hazard.

It is an object of the present invention to provide a digital radiography mechanical positioning system that is adjustable to rotate into a wheel chair use mode.

It is an object of the present invention to provide a digital radiography mechanical positioning system that utilizes a plurality of hard mechanical stops to prevent an X-ray source from a crashing into a patient when in a wheel chair use mode.

It is an object of the present invention to provide a digital radiography mechanical positioning system that is adjustable to further rotate into a wall-stand use mode.

It is an object of the present invention to provide a digital radiography mechanical positioning system where a plurality of the table use mode and the wheel chair use mode crash stops are disengaged as the vertical column is rotated to the wall-stand use position.

It is an object of the present invention to provide a digital radiography mechanical positioning system that provides a visual aid to an X-ray technician with a laser alignment feature that indicates an image collector field of view on a patient or a table when an image collector is hidden.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front overview of a digital radiography mechanical positioning system, in accordance with one embodiment of the present invention.

FIG. 2A illustrates a front perspective view of a floating table top of a digital radiography mechanical positioning system, in accordance with one embodiment of the present invention.

FIG. 2B illustrates a front perspective view of a table top frame end rail of a floating table top of a digital radiography mechanical positioning system, in accordance with one embodiment of the present invention.

FIG. 2C illustrates a front perspective view of a plurality of positions of a floating table top of a digital radiography mechanical positioning system, in accordance with one embodiment of the present invention.

FIG. 2D illustrates a rear perspective view of a pair of vertical column positions and a transitional rail system of a digital radiography mechanical positioning system, in accordance with one embodiment of the present invention.

FIG. 2E illustrates a pair of front perspective views of a vertical column in a first position and a simulated X-ray beam of a digital radiography mechanical positioning system, in accordance with one embodiment of the present invention.

FIG. 2F illustrates a pair of front perspective views of a vertical column in a second position and a simulated X-ray beam of a digital radiography mechanical positioning system, in accordance with one embodiment of the present invention.

FIG. 2G illustrates a pair of side perspective views of a C-arm, a trolley and a vertical column of a digital radiography mechanical positioning system, in accordance with one embodiment of the present invention.

FIG. 2H illustrates a side perspective view of an X-ray tube height control grip of a digital radiography mechanical positioning system, in accordance with one embodiment of the present invention.

FIG. 2I illustrates a pair of side perspective views of a laser light source of a digital radiography mechanical positioning system, in accordance with one embodiment of the present invention.

FIG. 2J illustrates a pair of rear perspective views of a rotational clearance of a vertical column and c-arm of a digital radiography mechanical positioning system, in accordance with one embodiment of the present invention.

FIG. 3A illustrates a front and side perspective view of a wheel chair use mode of a digital radiography mechanical positioning system, in accordance with one embodiment of the present invention.

FIG. 3B illustrates a front and rear perspective views of a plurality of wheel chair use mode positions of a digital radiography mechanical positioning system, in accordance with one embodiment of the present invention.

FIG. 4A illustrates a front and rear perspective view of a wall-stand use mode of a digital radiography mechanical positioning system, in accordance with one embodiment of the present invention.

FIG. 4B illustrates a rear perspective view of an approximate 20 degree wall-stand use mode of a digital radiography mechanical positioning system, in accordance with one embodiment of the present invention.

FIG. 5 illustrates a side perspective view of a Bucky system of a digital radiography mechanical positioning system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

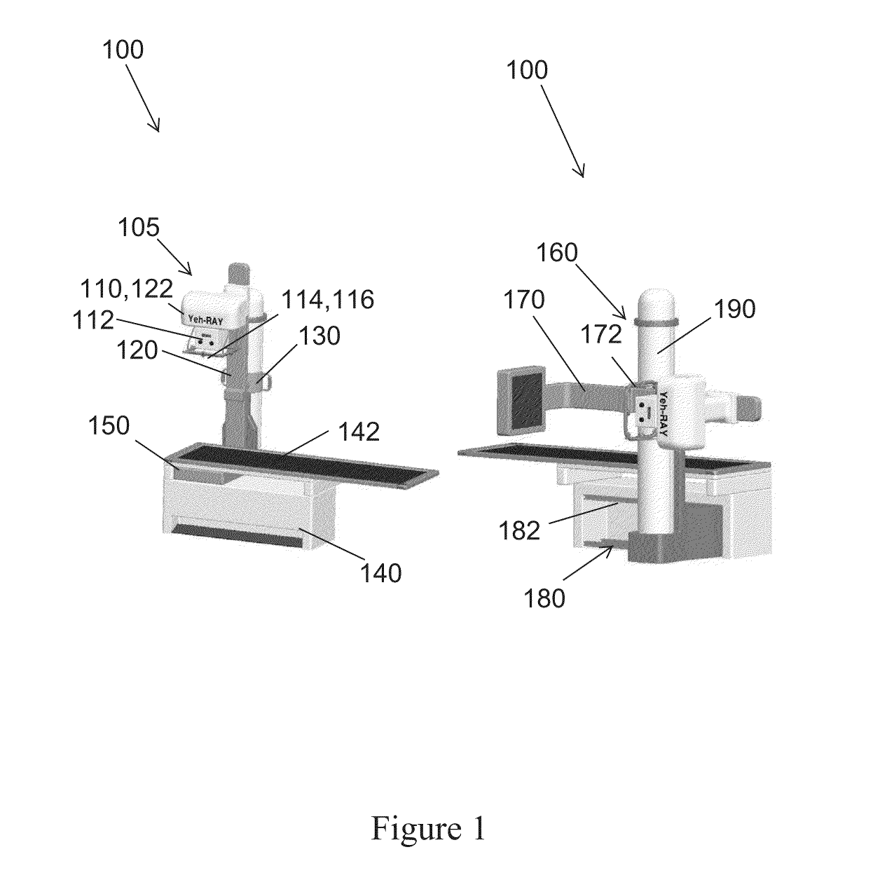

FIG. 1 illustrates a front overview of a digital radiography mechanical positioning system 100, in accordance with one embodiment of the present invention.

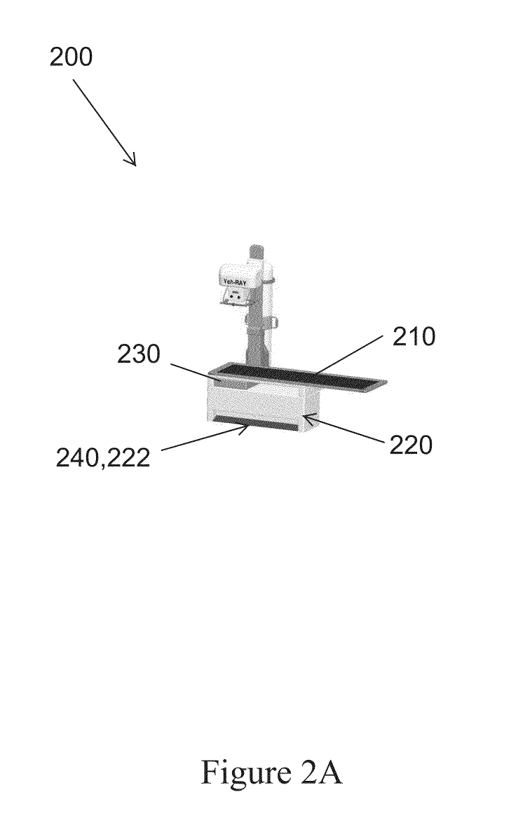

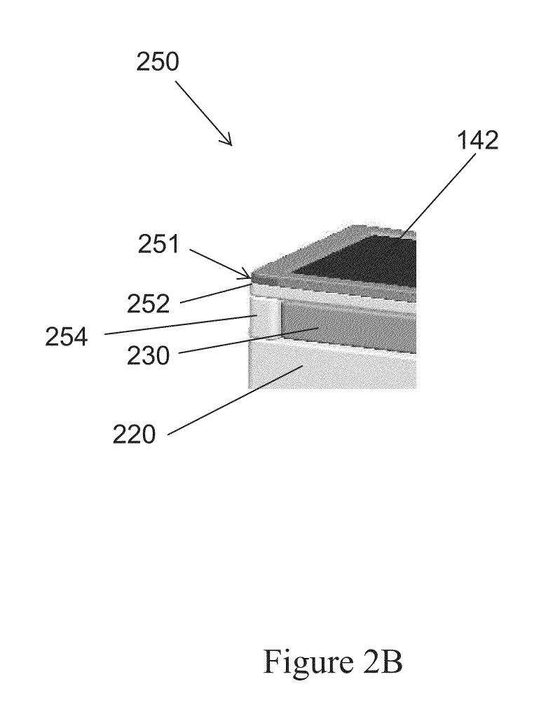

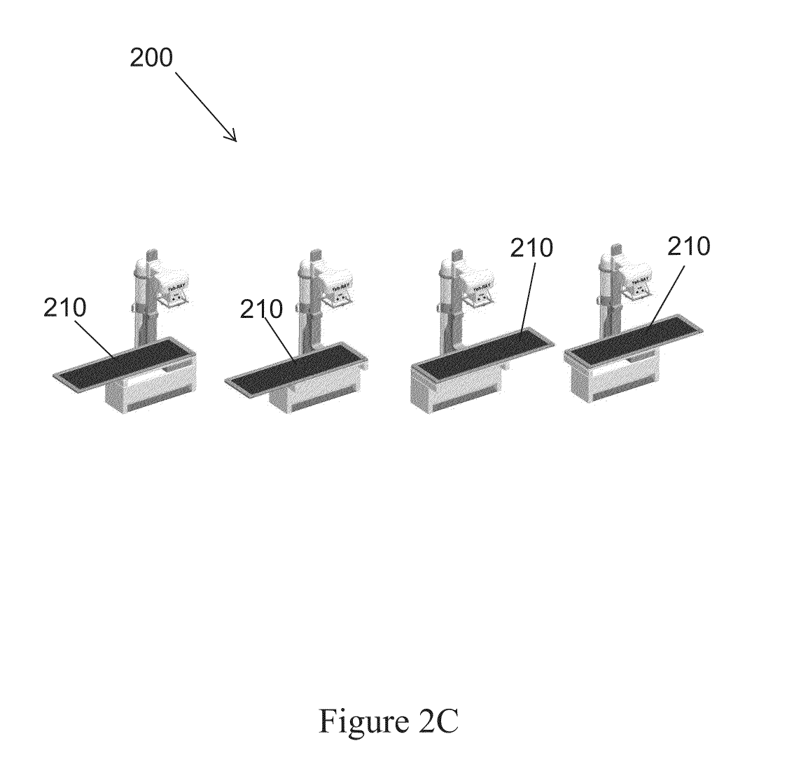

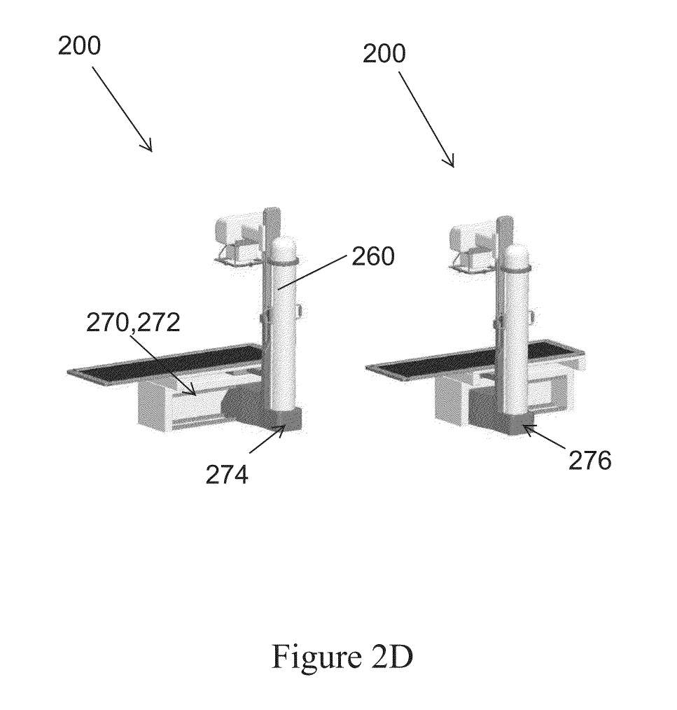

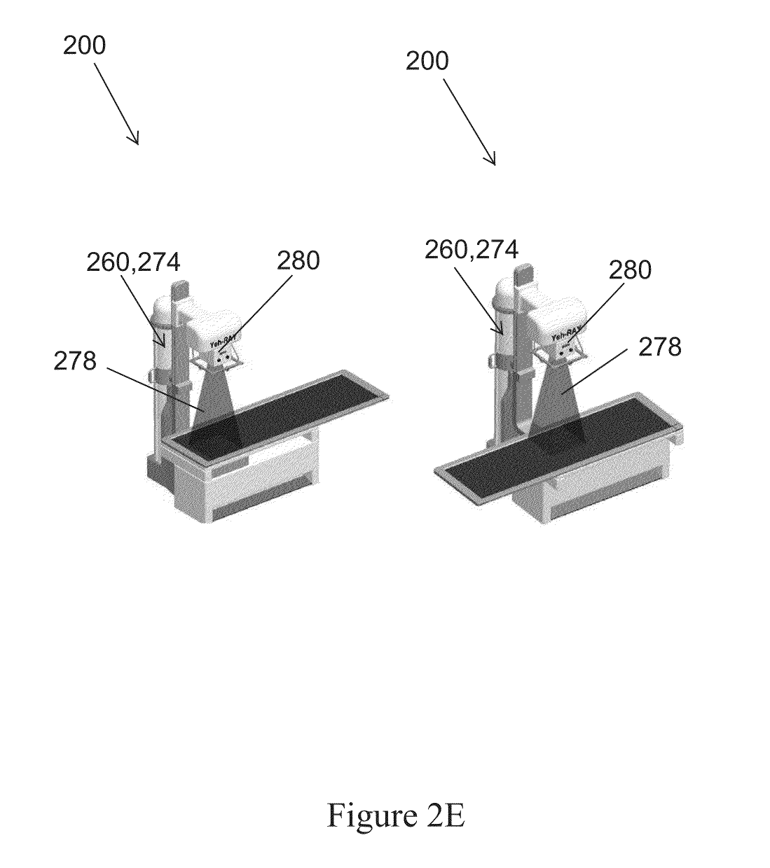

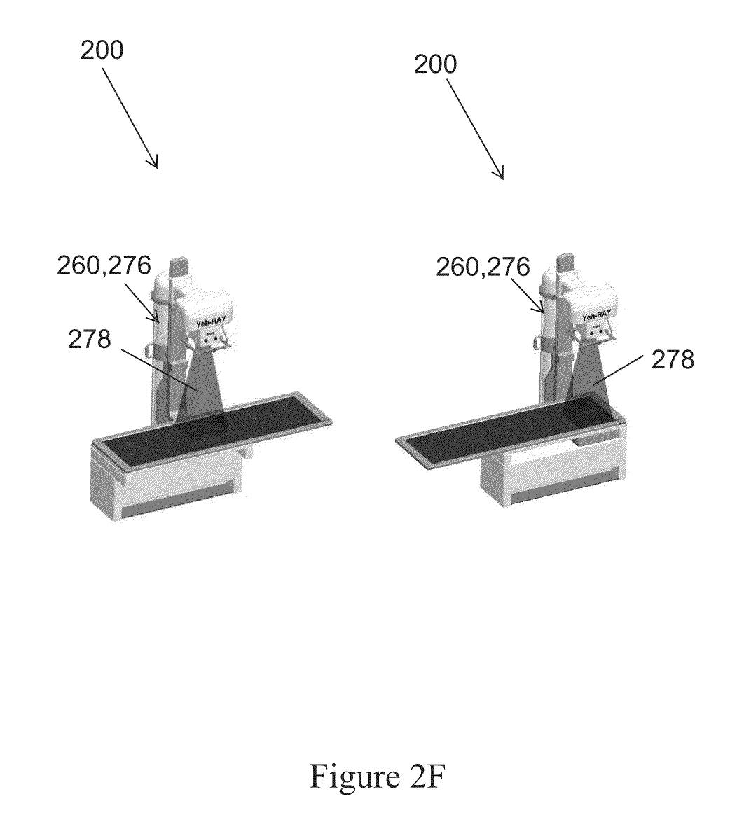

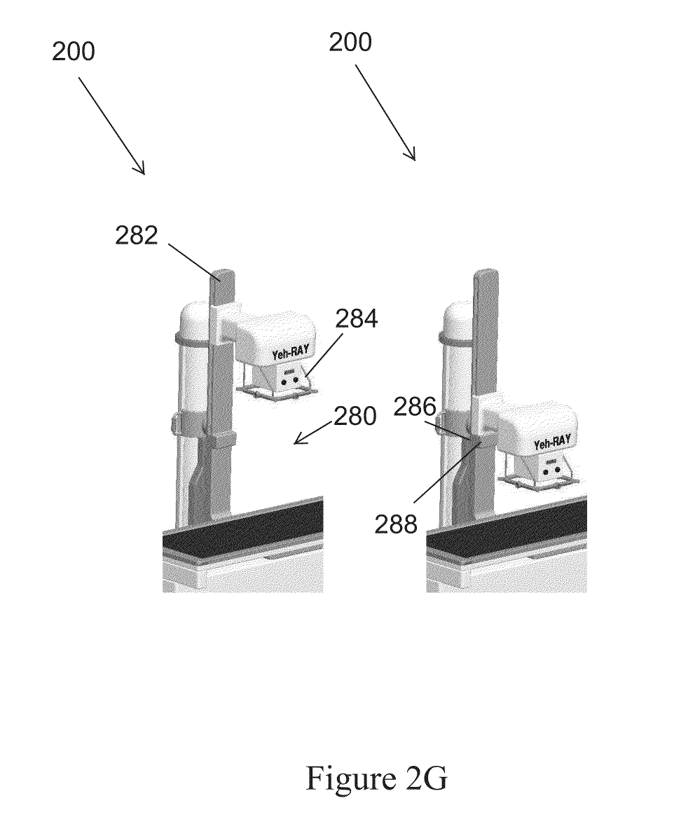

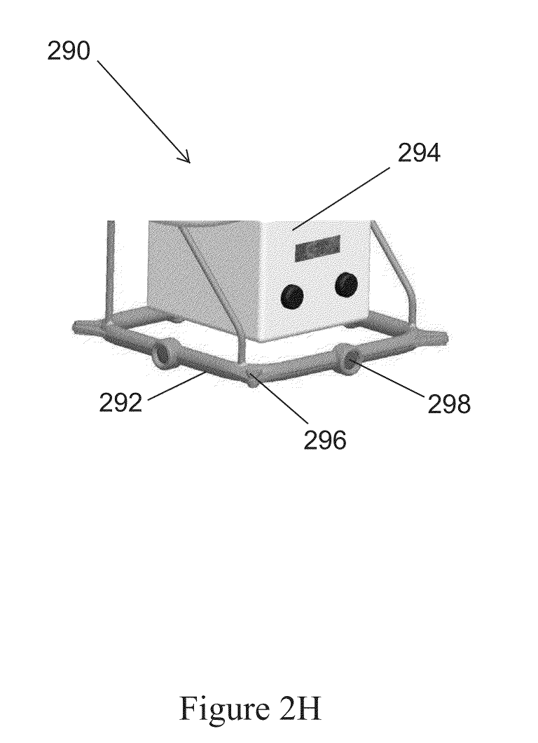

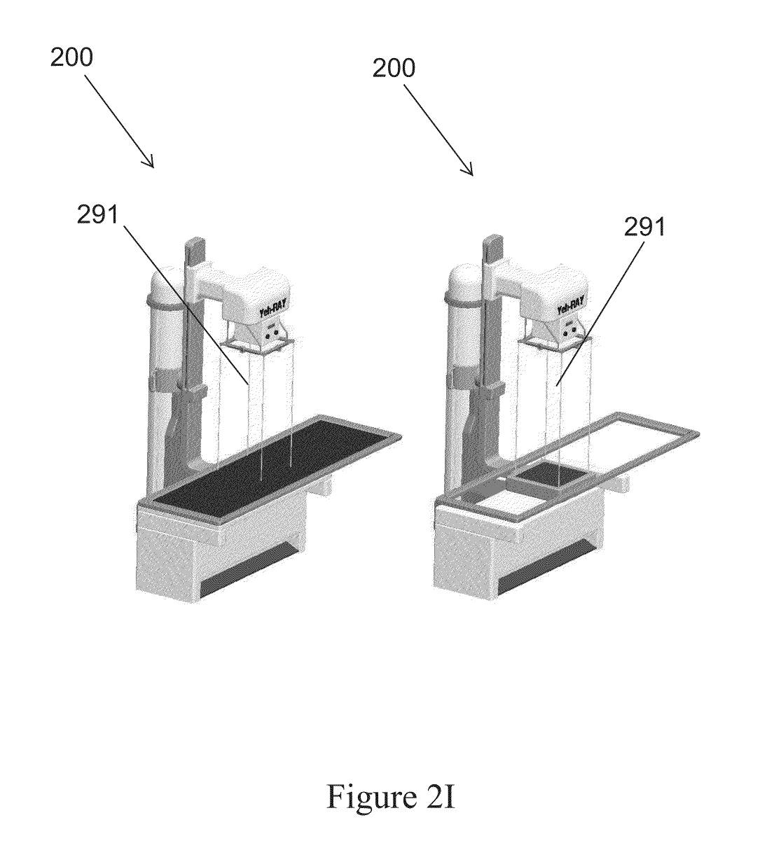

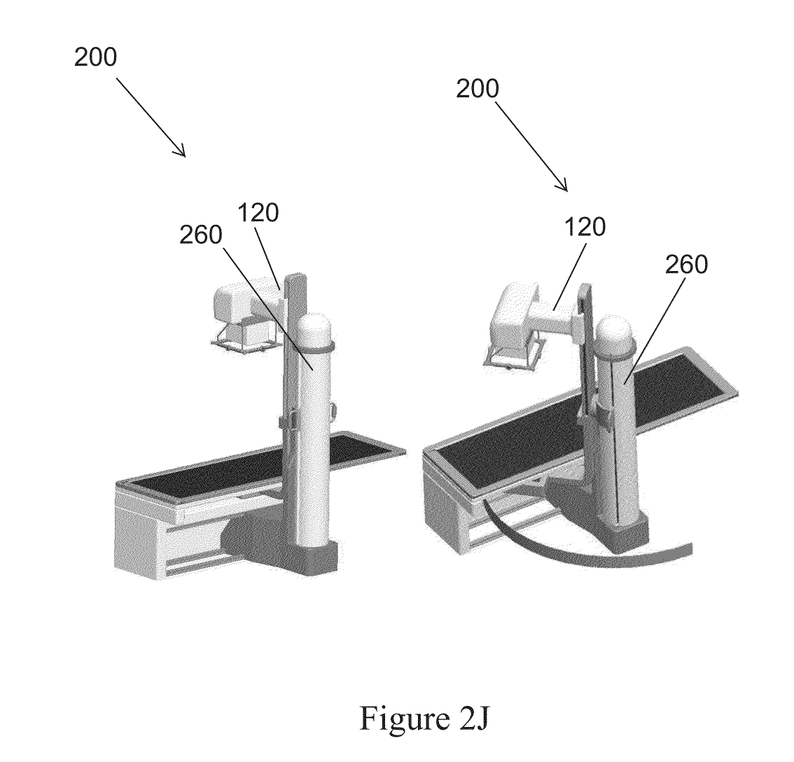

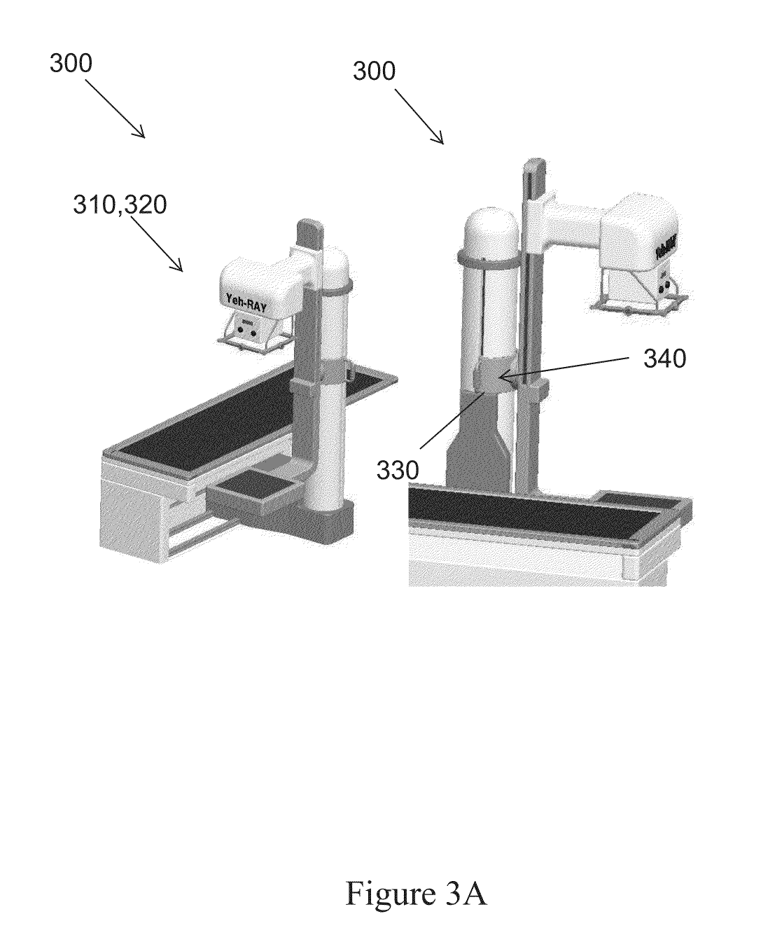

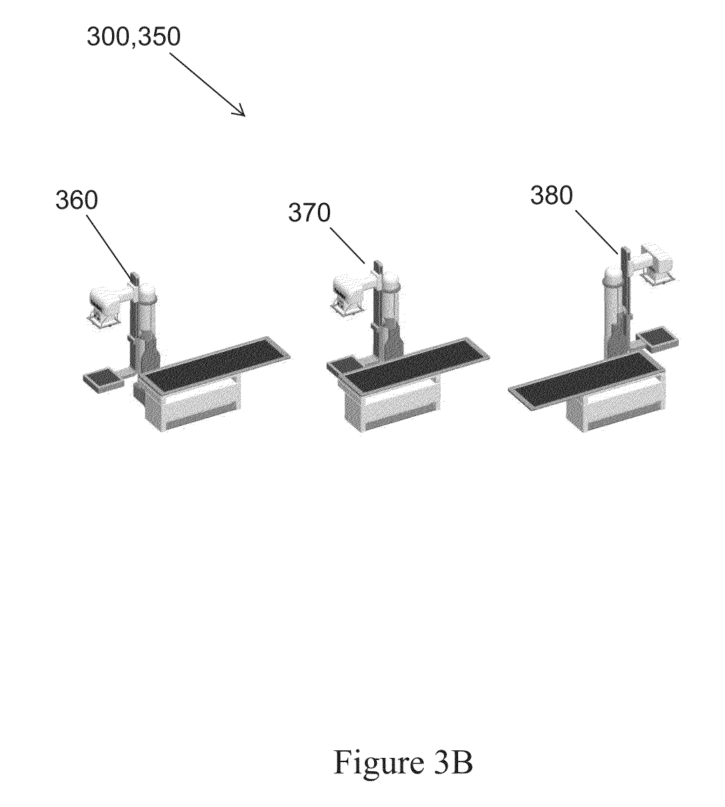

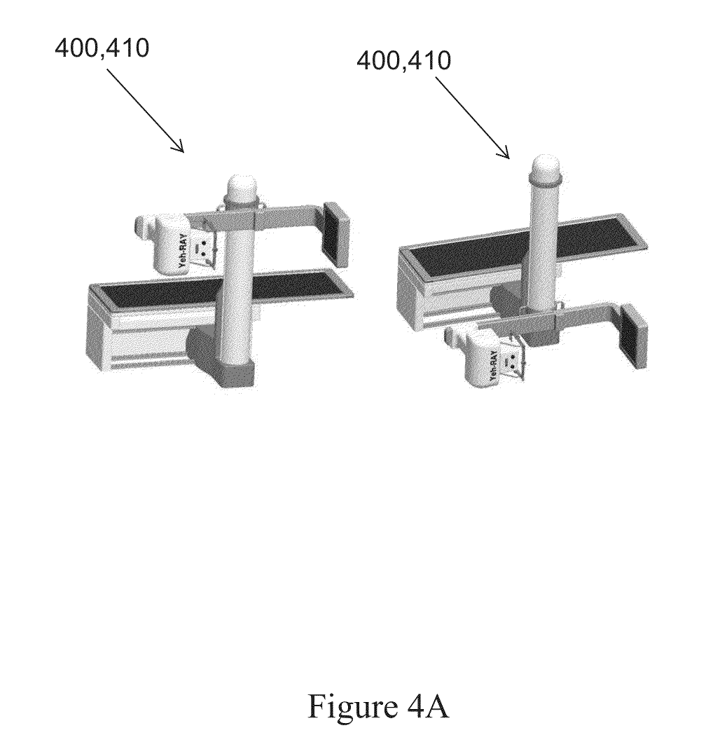

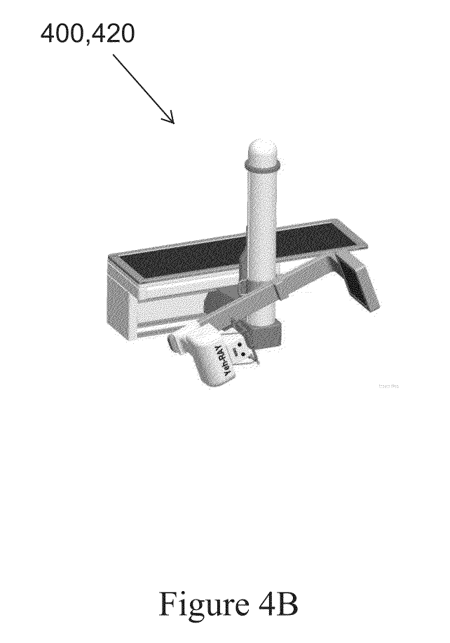

The digital radiography mechanical positioning system 100 includes a table use mode 105 with an X-ray source 110, a first C-arm position 120, a C-arm trolley 130, a dedicated table 140 and an image collector 150. Additional details regarding the table use mode 105 are provided in FIGS. 2A-2K. The digital radiography mechanical positioning system 100 also includes a wall stand use mode 160 with a second C-arm position 170, a table base 180 and a rotational vertical column 190. Additional details regarding the wall stand use mode 160 are provided in FIGS. 3A-3B and FIGS. 4A and 4B.

The X-ray source 110 is SID adjustable and includes a collimator 112 to narrow a plurality of X-ray beams 114 emitting from the X-ray source 110 to take a plurality of X-ray exposures 116. The first C-arm position 120 has a first end 122 where the X-ray source 110 is attached. The C-arm trolley 130 positions the first C-arm position 120 and the X-ray source 110 to allow the X-ray source 110 to take the X-ray exposures 116. The dedicated table 140 supports a floating table top 142 that receives a patient (not shown) that the X-ray exposures 116 are performed on with the X-ray source 110. The first C-arm position 120 is perpendicular to the floating table top 142. The floating table top 142 moves horizontally across the dedicated table 140. The image collector 150 collects the image of the patient that the X-ray exposures 116 obtain with the X-ray source 110.

The second C-arm position 170 has a first end 172 and is parallel to the floating table top 142 of the wall stand use mode 160. The table base 180 includes a transitional rail system 182 housed in the table base 180. The rotational vertical column 190 is perpendicularly attached to the first end 172 of the second C-arm position 170 and rotates the second C-arm position 170. The rotational vertical column 190 also moves horizontally along the transitional rail system 182 housed in the table base 180 to position the second C-arm position 170.

FIG. 2A illustrates a front perspective view of a floating table top 210 of a digital radiography mechanical positioning system 200, in accordance with one embodiment of the present invention. The floating table top 210 and the digital radiography mechanical positioning system 200 illustrated and described in FIG. 2A are similar to the floating table top 142 and the digital radiography mechanical positioning system 100 illustrated and described in FIG. 1. The floating table top 210 includes a dedicated table 220 and the image collector 230 illustrated and described in FIG. 2A that is similar to the dedicated table 140 and the image collector 150 illustrated and described in FIG. 1.

Additionally the floating table top 210 includes a foot brake pedal release 240 that is disposed on a bottom portion 222 of the dedicated table 220. The foot brake pedal release 240 can be depressed typically by foot to stop the movement of the floating table top 210.

The table top surface will float, which is defined as having a range of lateral and longitudinal freedom of movement. This movement is held locked by electro-magnet brakes. Two brake configurations can be implemented: the brakes can hold both lateral and longitudinal motions simultaneously or there can be two independent brakes to restrain the lateral and longitudinal motions independently. The location for the brake release mechanism is one or more pedals, located recessed in the bottom front of the table base.

The table top includes a thin flat plank of composite material that is non-degradable with an X-ray exposure image quality and a frame that surrounds the plank. The frame provides the features to engage the lateral and longitudinal motion system and the brake system in the table base, and provides a plurality of smooth rounded surfaces to protect the patient during access to, and egress from, the table top. The width of the frame sides and ends does not enter the field of view of the image collector.

FIG. 2B illustrates a front perspective view of a table top frame end rail 250 of a floating table top 210 of a digital radiography mechanical positioning system 200, in accordance with one embodiment of the present invention.

The table top frame end rail 250 is disposed on the perimeter 251 of the floating table top 210. The table top frame end rail 250 includes a finger pinch protector 252, a plurality of float and brake covers 254 and the previously mentioned dedicated table 220 and image collector 230. The finger pinch protector 252 prevents a user from pinching a finger or other suitable body part such as a hand. The float and brake covers 254 prevent exposure and protect the float and brake components of the table top frame end rail.

The table top frame end rail is the same approximate width as the table top float and brake cover. It can be seen that the table top end rail is in line with the image collector edge and that the frame end rail is not in the field of view. The table top frame end rail adds a finger pinch protector to prevent finger pinching. This adds a layer of material that is non-degradable from the X-ray image and prevents fingers form entering the roller bearing travel area beneath the table top assembly.

FIG. 2C illustrates a front perspective view of a plurality of positions of a floating table top 210 of a digital radiography mechanical positioning system 200, in accordance with one embodiment of the present invention. The floating table top 210 of a digital radiography mechanical positioning system 200 illustrated and described in FIG. 2C is similar to the floating table top 210 of the digital radiography mechanical positioning system 200 illustrated and described in FIGS. 1, 2A and 2B.

The motion range of the table side to side is approximately 1000 mm but can be any suitable distance. It can be seen that the table top end edges line-up with the table base edges at the extremes. The front to back range of motion is approximately 240 mm and again the table top side edges line-up with the table base front or back edges at the extremes. Note that this range of motion does not allow full coverage of the table. This is why a traditional Bucky system used a plurality of floor rails to allow the vertical column to move. The digital radiography mechanical positioning system uses a rail system to allow movement of the vertical column with respect to the floating table top. The rail system on the digital radiography mechanical positioning system is completely enclosed within the table base.

FIG. 2D illustrates a rear perspective view of a pair of vertical rotational column positions and a transitional rail system of a digital radiography mechanical positioning system 200, in accordance with one embodiment of the present invention.

The vertical rotational column 260 and the transitional rail system 270 illustrated and described in FIG. 2D is similar to the vertical rotational column 190 and the transitional rail system 182 illustrated and described in FIG. 1. The transitional rail system 270 illustrated and described in FIG. 2D is a 3 rail system 272 but can have any suitable number of rails such as 2 rails or 4 rails. The vertical rotational column 260 is illustrated in FIG. 2D in a first position 274 and in a second position 276.

There are two ways to achieve this motion. One way uses a stationary table base 180 and a movable vertical rotational column. The second way uses a stationary vertical column and the floating table base. The vertical rotational column is much heavier than the floating table top, even with a patient on the floating table top. Anchoring the vertical rotational column offers a structural advantage. There are advantages and disadvantages to both ways. A well-suited embodiment would result in a digital radiography mechanical positioning system that does not require any modification to the floor of the medical building. Such a system would be free standing and must provide sufficient stability to prevent tipping over under Food and Drug Administration or FDA test requirements. Regardless of which way is employed, the floating table top and the vertical rotational column completely house the transitional rail system within the table base, which eliminates a tripping hazard.

The range of motion of the vertical rotational column is approximately 875 millimeters. This range allows for complete coverage of the entire table top area with the vertical rotational column in either a first position or a second position. It is not necessary to take X-ray exposures with the vertical rotational column in between these two positions. Therefore an electro-magnet brake system is not required between the first position or the second position. Simple mechanical latches can be used to automatically lock and hold the first position or the second position.

FIG. 2E illustrates a pair of front perspective views of a vertical rotational column 260 in a first position 274 and a simulated X-ray beam 278 of a digital radiography mechanical positioning system 200, in accordance with one embodiment of the present invention.

The simulated X-ray beam 278 is emitted from an X-ray source 280 similar to the X-ray source 110 illustrated and described in FIG. 1 and its description.

FIG. 2E illustrates the vertical rotating column in a first position and a simulated X-ray beam. The vertical rotating column on the left shows the table top fully to the right and fully back. This places the vertical rotating column and the image collector in the front left corner of the table. The vertical rotating column on the right moves the table top to the extreme opposite range of motion, with the table top fully to the left and fully forward. It can be seen that more than half of the table top area can be covered with the vertical rotational column in the first position.

FIG. 2F illustrates a pair of front perspective views of a vertical rotational column 260 in a second position 276 and a simulated X-ray beam 278 of a digital radiography mechanical positioning system 200, in accordance with one embodiment of the present invention.

The vertical rotational column in the second position includes the remaining half of the table top is fully available for exposures.

FIG. 2G illustrates a pair of front perspective views of a vertical range of motion to adjust a source image distance 280 of a digital radiography mechanical positioning system 200, in accordance with one embodiment of the present invention.

The source image distance 280 includes an additional travel for wall-stand use mode 282, an SID control clip 284, a base extension safety stop 286 and a C-arm 288 safety stop.

The X-ray source is located at the upper side of the C-arm and has a vertical range of motion to adjust the SID. The weight of the X-ray source must be counterbalanced by mechanisms inside the c-arm for a manual system. This can be done by a spring, a gas piston, or a balance weight. The design is to minimize the force required by the X-ray technician to move the X-ray source. Another option is to motorize the SID adjustment. The SID is locked by an electro-magnet brake system and the release buttons are located on the grip bar.

The digital radiography mechanical positioning system provides a well suited safety feature. FIG. 2G on the left an X-ray tube in a typical use position. FIG. 2G on the right shows the X-ray tube in a lowest position. The lowest position provides a substantial gap between the table top and the movable X-ray tube. It should be noted that in the lowest position the C-arm cannot move any lower due to the base extension safety stop, and the X-ray tube cannot move any lower due to the C-arm safety stop. These stops are intended to withstand a system crash and provide a sufficient gap to protect a patient lying on the table. The base extension safety stop is shown as an element external to the vertical column. It is also possible to provide the base extension safety stop within the vertical column and have the same function.

The C-arm length is determined by the focal length requirements from the wall-stand use mode. Therefore, the length of vertical travel of the X-ray tube in table use mode is equal to or greater than the current Bucky system. FIG. 2G illustrates on the left that there is an additional travel range with the digital radiography mechanical positioning system for table use mode.

FIG. 2H illustrates a side perspective view of an X-ray tube height control grip 290 of a digital radiography mechanical positioning system 200, in accordance with one embodiment of the present invention.

The X-ray tube height control grip 290 includes a square grip bar 292, an X-ray collimator 294, a corner Laser alignment light 296 and a recessed brake release button 298.

FIG. 2H illustrates a close-up view of the X-ray tube height control grip. The grip bar is square shaped, which allows handling from any direction. The square grip bar is purposely at or below the lowest portion of the collimator. The height of the X-ray technician is an important ergonomic factor. The grip bar should be as low as is possible, without interfering with the X-ray image quality. This allows a shorter X-ray technician to manipulate the height of the X-ray tube without getting on a step-stool. This design also offers added protection to both the patient and the collimator.

Typically these buttons are located near the X-ray tube for one handed use by a technician. The digital radiography mechanical positioning system locates the various motion brake release buttons in different locations on the digital radiography mechanical positioning system to improve safety as well as make the button purpose more intuitive. FIG. 2H illustrates four buttons located on the grip bar. Two buttons are conspicuously placed and two more are partially hidden as they are on the opposite side. There is one button in the center of each leg of the square. All of these buttons have the same function to release the brake for vertical travel of the X-ray tube. The buttons are recessed to minimize an accidental activation. The digital radiography mechanical positioning system will require any two of the four buttons to be pushed to release the brake. This requires two handed operation and greatly reduces the likelihood that a patient will accidentally release the brake system while lying on the table. Even if that were to occur, the safety stops prevent a harmful crash. Release buttons for other system functions are located away from the X-ray tube grip bar.

FIG. 2I illustrates a pair of side perspective views of a laser light source 291 of a digital radiography mechanical positioning system 200, in accordance with one embodiment of the present invention.

The X-ray tube height adjust grip is also designed to be square for another reason. The corners will emit a light beam to show the technician the boundaries of the image collector viewing area. This area is not visible from the table top as the image collector is underneath the table top. The view area light would be activated by an on and off switch located on the grip bar. FIG. 2I on the left shows the light source turned on. Each corner has a low power Laser that is emitted straight down. This maintains the correct view area regardless of the height of the X-ray tube. The light beams define the corners of the approximate 17×17 inch image collector area. FIG. 2I on the right has the table top removed to show the image collector and light beam alignment. These are always coupled by the C-arm. The lighted image area is for the benefit of the X-ray technician as it will define the four corners of the image area to be collected. The table top can be manipulated and locked in a location that assures the patient is in the viewing area.

In conclusion, the table use mode offers several improvements over prior art. There are no C-arm adjustments needed to operate the system in table use mode. The C-arm rotation is locked, and the C-arm vertical position is locked. The SID is adjustable and the patient table float range offers an exposure area over more than half of the table area using a vertical rotational column of a first position. Most normal X-ray examinations can be taken with the vertical rotational column in a first position. The only time the vertical rotational column needs to be moved to a second position is when the patient requires a full body length series of images and the patient cannot be moved once upon the table top. The X-ray source and the image collector are always coupled for alignment, and there is a feature to enable the technician to visualize the image area without being able to see the image collector. The image collector is 17×17 inch so there is no need to provide image collector rotation. Most importantly, the patient is much safer with system crash protection.

FIG. 2J illustrates a pair of rear perspective views of a rotational clearance of a vertical rotation column 260 and a first c-arm 120 of a digital radiography mechanical positioning system 200, in accordance with one embodiment of the present invention.

The vertical rotational column and the C-arm vertical position are locked for the table use mode. The vertical column is also locked into either a first position or a second position on the rail system. FIG. 2J left shows the system in table use mode with the vertical column in a first position. To exit the table use mode, the vertical rotational column rotation must be unlocked. Then the vertical rotational column can be rotated 90 degrees about its vertical axis to enter the wheel chair use mode, or 180 degrees to enter the wall-stand use mode. The C-arm rotation about the trolley horizontal axis remains locked during rotation of the vertical rotational column. This retains the C-arm in a vertical orientation while the C-arm trolley remains locked at one vertical height. FIG. 2J shows that there is ample clearance for the vertical rotation column with the table top positioned fully toward the vertical rotation column. This rotational clearance is the same when the vertical rotation column is in a first position or a second position, however, the vertical rotational column must be one of those two positions and not in-between. The vertical rotational column is locked with a vertical column rotational lock located in the base. This lock is coupled to the first lock in the first position and a second lock in the second position such that the vertical rotatable column cannot be rotated unless one of the locks is engaged. One embodiment of the digital radiography mechanical positioning system is to allow vertical column rotation from either the first position or the second position. Another embodiment restricts the vertical column such that rotation is only possible from one of the first position or the second position. The column rotation has three use positions at approximately 0, 90, and 180 degrees. A fourth position at 270 degrees is also feasible. The lock system will automatically engage when selecting and entering one of these positions.

FIG. 3A illustrates a front and side perspective view of a wheel chair use mode 310 of a digital radiography mechanical positioning system 300, in accordance with one embodiment of the present invention.

The wheel chair use mode 310 includes a first position at 90 degrees 320, a base extension stop 330 and a c-arm trolley 340.

FIG. 3A shows the digital radiography mechanical positioning system set-up for wheel chair use mode. The vertical column has been rotated approximately 90 degrees in the first position. The C-arm trolley remains locked by the C-arm trolley vertical lock, and the base extension safety stop remains effective over the approximately 90 degrees of vertical column rotation. This keeps the image collector at the same height as for table use mode. The X-ray tube arm has the same vertical motion range, and the digital radiography mechanical positioning system has the same crash protection features active. The exposures can be taken without the table in the way and wheel chair access available.

FIG. 3B illustrates a front and rear perspective views of a plurality of wheel chair use mode positions 350 of a digital radiography mechanical positioning system 300, in accordance with one embodiment of the present invention.

The wheel chair use mode positions 350 include a first position 270 degree rotation 360, a second position 270 degree rotation 370 and a second position in a 90 degree rotation 380.

It is possible to permit other wheel chair use positions. It is highly preferable from a safety standpoint to have the C-arm trolley vertical lock engaged and the base extension safety stop in place while in any wheel chair use position. This eliminates the possibility of a crash into the wheel chair. The system will be a simpler design if there is only one wheel chair use rotational position. The access and ergonomics need to be studied to determine whether the system uses one or two wheel chair use positions.

FIG. 4A illustrates a front and rear perspective view of a wall-stand use mode 410 of a digital radiography mechanical positioning system 400, in accordance with one embodiment of the present invention.

FIG. 4A show the upper and lower extremes of the C-arm vertical positioning. The lowest extreme of the X-ray tube and image collector are slightly above floor level. The C-arm trolley has a hard stop at this position. The digital radiography mechanical positioning system eliminates the crash potential by retaining the C-arm locked horizontally. The upper extreme position is approximately 1500 mm above the lowest position. The C-arm is height adjustable between these two extremes. The system will use a chain coupled counter-balance system to minimize the force required to lift the C-arm.

An electro-magnetic brake system on the C-arm trolley will be used to hold the desired vertical position. This EM brake system is independent and separate from the C-arm trolley vertical lock. The EM brake system will be activated only when the vertical column is in the approximate 180 degree wall-stand use mode position, and the c-arm trolley vertical lock will be disengaged. Two EM brake release buttons will be located on the C-arm trolley. This will require the technician to use two hands to move the C-arm up and down and will minimize accidental brake deactivation by a patient. In addition, the system will use an emergency brake system for the wall-stand use mode. This brake is a passive brake that engages only when the C-arm trolley suddenly drops.

The X-ray tube is adjustable horizontally for the wall-stand use mode to adjust the SID. The digital radiography mechanical positioning system provides the same wall-stand use mode functionality as the traditional Bucky system. The digital radiography mechanical positioning system is an improvement as the X-ray source and image collector are always coupled. The digital radiography mechanical positioning system is an improvement over the prior art C-arm systems because the components cannot crash into the floor.

The digital radiography mechanical positioning system omits exposure positions with the C-arm rotation between vertical and horizontal. This eliminates the need for the C-arm to be balanced during wall-stand use mode. This is an important factor because to balance the system requires additional weight to be added. The traditional C-arm prior art is very heavy, and the FDA testing is predicated on the weight of the components. So the digital radiography mechanical positioning system that operates effectively without C-arm balance will be lighter, thus more cost effective, and it reduces the FDA testing weight requirements.

FIG. 4B illustrates a rear perspective view of an approximate 20 degree wall-stand use mode 420 of a digital radiography mechanical positioning system 400, in accordance with one embodiment of the present invention.

The patient must stand on a pedestal for this exposure. This exposure angle can be achieved with the digital radiography mechanical positioning system if there is a C-arm rotational release mechanism at one discreet height location. The mechanism would require a switch such that the height is locked, and the C-arm can rotate only 20 degrees and be locked. The height lock would remain engaged until the rotation is returned to horizontal and the primary C-arm rotation lock is re-engaged.

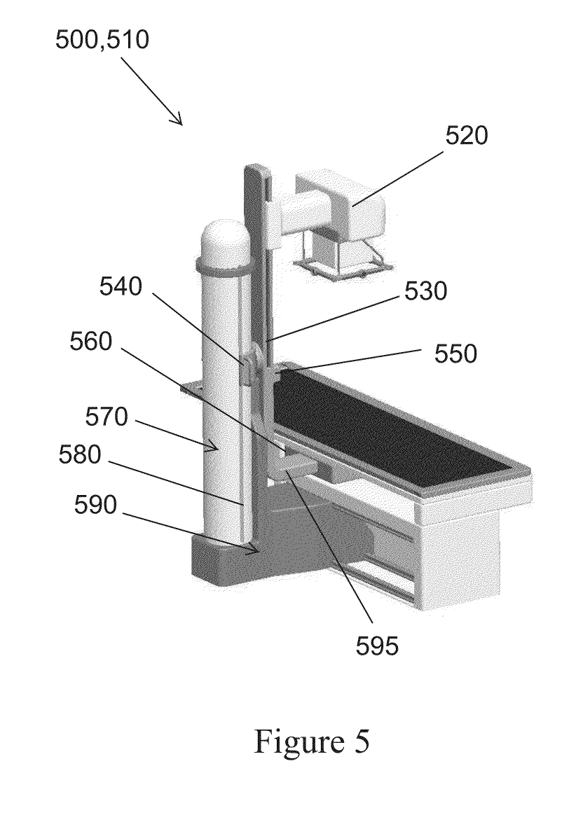

FIG. 5 illustrates a side perspective view of a Bucky system 510 of a digital radiography mechanical positioning system 500, in accordance with one embodiment of the present invention.

The Bucky system 510 includes an X-ray tube and arm 520, an arm guide slot 530, a trolley 540, a C-arm hard stop 550, an image collector 560, a vertical column 570, a trolley guide slot 580, a base 590 and a C-arm 595.

The original Bucky system was set up for standard 14×17 inch radiographic film. This carried over into the digital age and most current Bucky systems use 14×17 digital image collectors in two locations. Both collectors use a mechanical rotation system so that the rectangular area can be set up in land or portrait mode. The digital radiography mechanical positioning system uses one 17×17 inch image collector. This is more expensive than one 14×17 digital image collector, but it is much less expensive than two of them and the rotation mechanism and clearance issues for the image collector rotation are eliminated.

The digital radiography mechanical positioning system uses a C-arm that is fastened to a trolley that can roll up and down the vertical column. The entire vertical column has the ability to rotate on its base. In table use mode the c-arm is locked in one dedicated vertical position such that the image collector is at the correct height within the table. The C-arm rotation is also locked to hold the X-ray beam vertical. The C-arm mechanically holds the alignment of the X-ray source and the image collector, thus potential coupling problems of the Bucky system are eliminated.

Most importantly, the digital radiography mechanical positioning system uses hard stops to prevent the possibility of the X-ray tube crashing into the patient or table. The base has a vertical post that extends up. This post prevents the C-arm trolley from dropping if there is a failure of the vertical C-arm lock. The X-ray tube arm can be positioned vertically on the C-arm to adjust the SID. The C-arm has a hard stop at the lowest position.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A rotary C-arm type of digital radiographic mechanical positional system mounted on a floor, comprising:
a fixed vertical column with a rotational freedom to attain a plurality of different use positions with a lockout capability that extends from the floor;
an X-ray source that provides the system with a plurality of X-rays;
a locking rotary c-arm with a distal end, the locking rotary C-arm extends horizontally from the column in a selected one of a vertical and a horizontal mode;
a single image collector disposed on the distal end of the rotary arm, the single image collector receives the X-rays after the X-rays are emitted from the X-ray source, the X-rays are absorbed by a patient that produces one or more exposures of the patient;
a rotatable wheeled trolley that is attached to the rotary C-arm and the X-ray source, the rotatable wheeled trolley vertically moves the rotary C-arm and the X-ray source along the vertical column; and
one or more safety stops.

2. The system according to claim 1, wherein the X-ray source has 3 motion brake release buttons.

3. The system according to claim 1, wherein the rotary C-arm aligns the X-ray source with the image collector to produce the one or more exposures of the patient.

4. The system according to claim 1, wherein the rotary C-arm is a selected one of a manually operated rotary C-arm and a motorized rotary C-arm.

5. The system according to claim 1, wherein the rotary C-arm is in a horizontal mode.

6. The system according to claim 1, wherein the rotary C-arm and the image collector are in a vertical position with a top and a bottom, with the rotary arm in the top vertical position and the image collector in the bottom position.

7. The system according to claim 6, wherein the vertical position produces the one or more exposures of the patient on a table.

8. A radiographic mechanical positional Bucky system, comprising:
a tube-stand set on a floor;
a locking rotary C-arm with a distal end, the locking rotary C-arm movably attached to the tube-stand in a selected one of a vertical mode and a horizontal mode;
an X-ray source attached to the distal end of the C-arm;
a single image collector in alignment with the X-ray source;
a patient table with a floating top surface, the floating top surface is made of composite material that is non-degradable upon one or more exposures where a patient is positioned on the top surface in the alignment between the image collector and the X-ray source, the X-ray source to produce the one or more exposures of the patient; and
one or more safety stops.

9. The system according to claim 8, wherein the tube-stand includes a plurality of stops to prevent the arm from striking a selected one of the patient and the patient table.

10. The system according to claim 9, wherein the tube-stand includes a 4 corner laser visual guide to locate the patient correctly over the image collector.

11. The system according to claim 8, wherein the rotary C-arm is a selected one of a manually operated rotary C-arm and a motorized rotary C-arm.

12. The system according to claim 8, wherein the system is mounted on a plurality of floor rails to roll the system across the patient table.

13. The system according to claim 8, wherein the system is a selected one of a digital system and an analog system.

14. A radiographic mechanical positional Bucky system, comprising:
a tube-stand;
a wall mount;
a locking rotary C-arm with a distal end, the locking rotary C-arm movably integral to the tube-stand in a selected one of a vertical mode and a horizontal mode;
an X-ray source disposed on the distal end of the arm;
a single image collector is disposed on the wall mount in alignment with the X-ray source;
a patient table with a floating top surface made of composite material that is non-degradable upon one or more exposures where a patient is positioned on the top surface in the alignment between the image collector and the X-ray source, the X-ray source to produce the one or more exposures of the patient; and
one or more stops.

15. The system according to claim 14, wherein the rotary C-arm is manually operated.

16. The system according to claim 14, wherein the rotary C-arm is motorized.

17. The system according to claim 14, wherein the system is mounted on a plurality of floor rails to roll the system across the patient table.

18. The system according to claim 17, wherein the patient table includes a 4 corner laser visual guide to correctly locate the patient over the image collector.

19. The system according to claim 14, wherein the system is a selected one of a digital system and an analog system.

20. The system according to claim 14, wherein the patient stands on a stand in front of the image collector to produce the one or more exposures.
